(19) United States
(12) Patent Application Publication
(10) Pub. No.: US 2025/0121406 A1
(43) Pub. Date: Apr. 17, 2025

(54) ELECTRODE MANUFACTURING APPARATUS AND ELECTRODE MANUFACTURING METHOD

(71) Applicant: SAMSUNG SDI CO., LTD., Suwon-si (KR)

(72) Inventor: Eun Kang LEE, Suwon-si (KR)

(21) Appl. No.: 18/619,641

(22) Filed: Mar. 28, 2024

(30) Foreign Application Priority Data
Oct. 13, 2023 (KR) 10-2023-0136962

(51) Int. Cl. B05D 7/00; F26B 3/20; H01M 4/04

(52) U.S. Cl. CPC B05D 7/544; H01M 4/0404; H01M 4/0435; F26B 3/20

(57) ABSTRACT

An electrode manufacturing apparatus and an electrode manufacturing method, the apparatus includes a first coater configured to coat a first surface of a current collector with an electrode active material slurry; and a first dryer configured to come into contact with the current collector that has passed through the first coater and heat the current collector.

### CROSS-REFERENCE TO RELATED APPLICATION

The present application claims priority and the benefit of Korean Patent Application No. 10-2023-0136962, filed on Oct. 13, 2023, in the Korean Intellectual Property Office, the entire disclosure of which is incorporated herein by reference.

### BACKGROUND

### 1. Field

Embodiments relate to an electrode manufacturing apparatus and an electrode manufacturing method.

### 2. Discussion of Related Art

Generally, as the demand for portable electronic products such as laptops, video cameras, and portable phones increases rapidly and the commercialization of robots and electric vehicles begins in earnest, research on high-performance secondary batteries capable of being repeatedly charged and discharged is actively underway.

A secondary battery may include an electrode assembly provided with a pair of electrodes, e.g., a positive electrode and a negative electrode, and a separator between the pair of electrodes. The electrodes of the secondary battery may include a current collector and a cured electrode active material with which one or both sides of the current collector are coated.

### SUMMARY

The embodiments may be realized by providing an electrode manufacturing apparatus including a first coater configured to coat a first surface of a current collector with an electrode active material slurry; and a first dryer configured to come into contact with the current collector that has passed through the first coater and heat the current collector.

The first dryer may include at least one first drying main heating roller configured to come into contact with the electrode active material slurry coated on the first surface and heat the electrode active material slurry; and at least one first drying supplementary heating roller configured to come into contact with a second surface of the current collector and heat the second surface.

The at least one first drying main heating roller and the at least one first drying supplementary heating roller may be alternately disposed in a traveling direction of the current collector.

A heating temperature of the at least one first drying main heating roller may be higher than a heating temperature of the at least one first drying supplementary heating roller.

The at least one first drying main heating roller may include a plurality of first drying main heating rollers; and heating temperatures of the plurality of first drying main heating rollers may gradually increase in a traveling direction of the current collector.

The at least one first drying supplementary heating roller may include a plurality of first drying supplementary heating rollers; and heating temperatures of the plurality of first drying supplementary heating rollers may gradually increase in a traveling direction of the current collector.

The first dryer may further include at least one first drying preheating roller ahead of the at least one first drying main heating roller and the at least one first drying supplementary heating roller in a traveling direction of the current collector, the at least one first drying preheating roller being configured to come into contact with the second surface and heat the second surface.

The first dryer may further include a first chamber that accommodates the at least one first drying main heating roller and the at least one first drying supplementary heating roller, and through which the current collector passes; and a first ventilator configured to discharge a material generated from the electrode active material slurry to the outside of the first chamber.

The electrode manufacturing apparatus may further include a second coater configured to coat a second surface of the current collector with an electrode active material slurry that has passed through the first dryer; and a second dryer configured to come into contact with the current collector that has passed through the second coater and heat the current collector.

The second dryer may include at least one second drying main heating roller configured to come into contact with the electrode active material slurry coated on the second surface and heat the electrode active material slurry; and at least one second drying supplementary heating roller configured to come into contact with the first surface of the current collector and heat the first surface.

The at least one second drying main heating roller and the at least one second drying supplementary heating roller may be alternately disposed in a traveling direction of the current collector.

A heating temperature of the at least one second drying main heating roller may be higher than a heating temperature of the at least one second drying supplementary heating roller.

The at least one second drying main heating roller may include a plurality of second drying main heating rollers; and heating temperatures of the plurality of second drying main heating rollers may gradually increase in a traveling direction of the current collector.

The at least one second drying supplementary heating roller may include a plurality of second drying supplementary heating rollers; and heating temperatures of the plurality of second drying supplementary heating rollers may gradually increase in a traveling direction of the current collector.

The second dryer may further include at least one second drying preheating roller ahead of the at least one second drying main heating roller and the at least one second drying supplementary heating roller in a traveling direction of the current collector, the at least one second drying preheating roller being configured to come into contact with the first surface and heat the first surface.

The second dryer may further include a second chamber that accommodates the at least one second drying main heating roller and the at least one second drying supplementary heating roller, and through which the current collector passes; and a second ventilator configured to discharge a material generated from the electrode active material slurry to the outside of the second chamber.

The embodiments may be realized by providing an electrode manufacturing method, the method including performing a first electrode active material slurry coating operation of coating a first surface of a current collector with an electrode active material slurry; and performing a first drying operation including a first drying main heating operation in which a first drying main heating roller comes into contact with the electrode active material slurry coated on the first surface, and heats the electrode active material slurry, and a first drying supplementary heating operation in which a first drying supplementary heating roller comes into contact with a second surface and heats the second surface.

The first drying main heating operation may be performed a plurality of times; the first drying supplementary heating operation may be performed a plurality of times; and the first drying main heating operation and the first drying supplementary heating operation may be alternately performed the plurality of times.

The electrode manufacturing method may further include performing a second electrode active material slurry coating operation of coating the second surface of the current collector with an electrode active material slurry after performing the first drying operation; and performing a second drying operation including a second drying main heating operation in which a second drying main heating roller comes into contact with the electrode active material slurry coated on the second surface, and heats the electrode active material slurry, and a second drying supplementary heating operation in which a second drying main heating roller comes into contact with the first surface and heats the first surface.

The second drying main heating operation may be performed a plurality of times; the second drying supplementary heating operation may be performed a plurality of times; and the second drying main heating operation and the second drying supplementary heating operation may be alternately performed the plurality of times.

### RIEF DESCRIPTION OF THE DRAWINGS

Features will be apparent to those of skill in the art by describing in detail exemplary embodiments with reference to the attached drawings in which:

FIG. 1 is a diagram illustrating an electrode manufacturing apparatus according to one embodiment;

FIG. 2 is a configuration diagram illustrating a first dryer of FIG. 1;

FIG. 3 is a configuration diagram illustrating a second dryer of FIG. 1;

FIG. 4 is an enlarged view illustrating portion IV of FIG. 1;

FIG. 5 is an enlarged view illustrating portion V of FIG. 2;

FIG. 6 is an enlarged view illustrating portion VI of FIG. 3;

FIG. 7 is an enlarged view illustrating portion VII of FIG. 1;

FIG. 8 is a flowchart illustrating an electrode manufacturing method according to one embodiment;

FIG. 9 is a flowchart illustrating a first drying operation of FIG. 8 in detail; and

FIG. 10 is a flowchart illustrating a second drying operation of FIG. 8 in detail.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

Before describing the embodiments, terms or words used herein and the appended claims should not be construed to be limited to ordinary or dictionary meanings, and should be interpreted in accordance with the meaning and concept consistent with the technical spirit of the embodiments.

In addition, the terms “comprise,” “include,” “comprising,” and/or “including” used herein specify the presence of stated shapes, numbers, steps, operations, members, elements, and/or groups thereof and do not exclude the presence or addition of one or more other shapes, numbers, operations, members, elements, and/or groups.

The statement that two objects of comparison are “the same” means that they are “substantially the same.” Therefore, “substantially the same” can include a deviation that is considered low in the art, for example, a deviation within 5%. In addition, uniformity of a parameter in a certain area may mean uniformity from an average perspective.

Although the terms first, second, and the like are used to describe various components, of course, these components are not limited by these terms. These terms are used only to distinguish one component from another component, and of course, unless otherwise stated, a first component may also be a second component, and are not intended to imply or require sequential inclusion.

Throughout the specification, unless otherwise stated, each element may be in a singular or plural form.

The arrangement of any component on “top (or bottom)” of a component or “on (or below)” of a component means that any component may be disposed in contact with an upper surface (or lower surface) of the component and may mean that other components may be interposed between the component and any component disposed on (or below) the component.

In addition, when a first component is described as “on,” “connected to,” or “coupled to” a second component, the components may be directly connected or linked to each other, but it should be understood that a third component may be “interposed” between the components, or that each component may be “connected,” “coupled,” or “linked” through the third component.

As used herein, the terms “or” and “and/or” are not exclusive terms, and include any one and all combinations of one or more related and listed items. In addition, the use of “may” when describing embodiments of the present disclosure relates to “one or more embodiments of the present disclosure.” Expressions such as “one or more” and “at least one” preceding a list of elements modify the entire list of elements and do not modify individual elements in the list.

Throughout the specification, when referring to “A and/or B,” this means A, B or A and B unless otherwise stated, and when referring to “C to D,” this means C or more and D or less unless otherwise stated.

When phrases such as “at least one of A, B, and C,” “at least one of A, B, or C,” “at least one selected from the group A, B, and C,” and “at least one selected from A, B, and C” are used to specify a list of elements A, B, and C, the phrases may refer to any and all suitable combinations.

The term “use” and the term “utilize” may be considered to be synonyms. As used herein, the terms “substantially,” “about,” and similar terms are used as terms of approximation rather than terms of degree and this is to take into account an inherent variation in value, which is measured or calculated, that a general engineer in the art would recognize.

For ease of description, spatially relative terms such as “beneath,” “below,” “lower,” “above,” and “upper” may be used to describe a relationship between one element or feature and other element(s) or feature(s) as shown in the drawings. A spatially relative position will be understood to encompass different directions of a device in use or operation in addition to a direction depicted in the drawings. For example, when a device in the drawing is turned over, elements described as “below” or “beneath” are understood to be “on” or “above” other elements. Thus, the term “below” can encompass both upward and downward directions.

In exemplary embodiments of cylindrical/prismatic/pouch batteries according to one embodiment of the present disclosure, one of the cylindrical/prismatic/pouch batteries is selected and the selected battery is described as having a general structure, and for commonly applied technologies, general structures of the cylindrical/prismatic/pouch batteries are described.

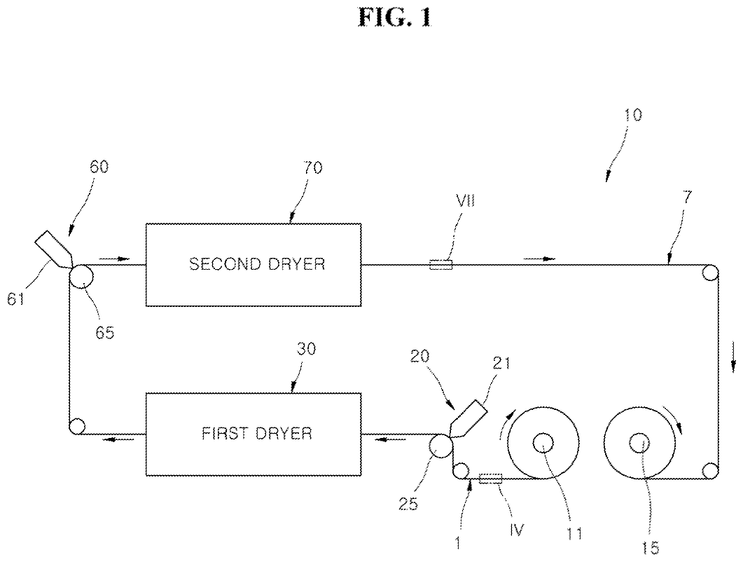

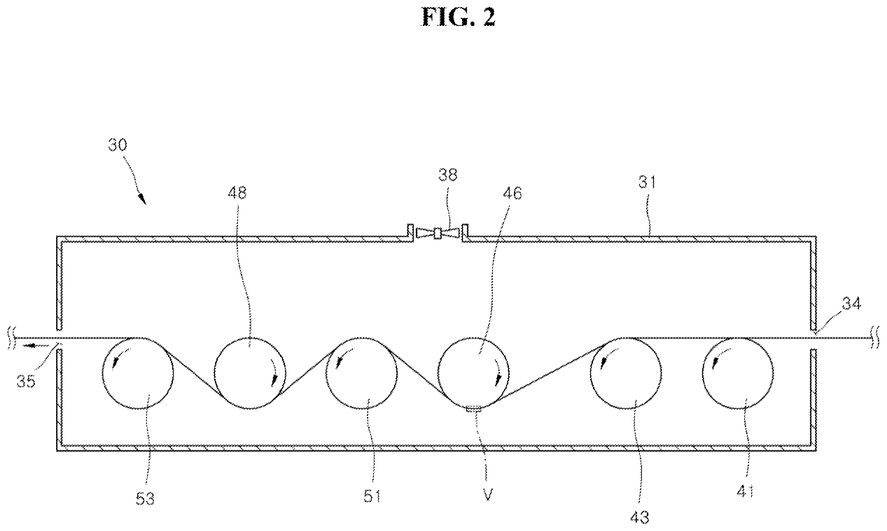

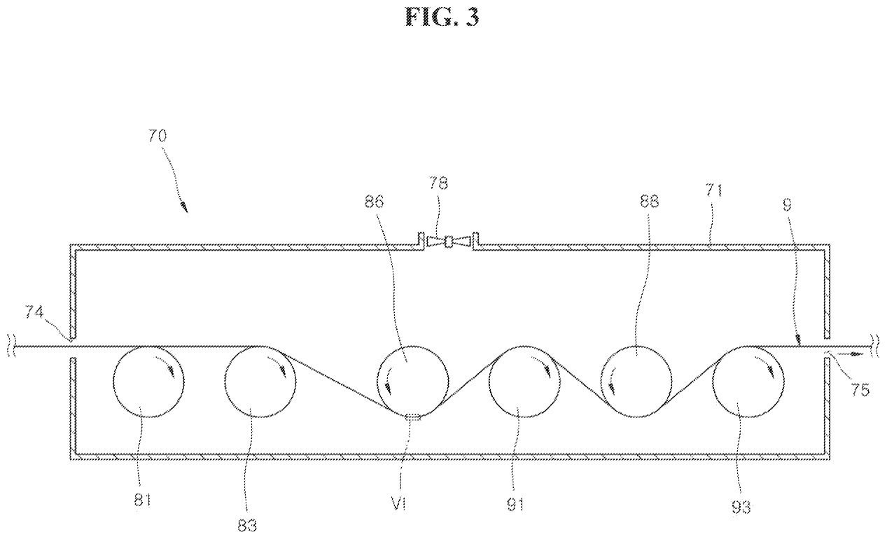

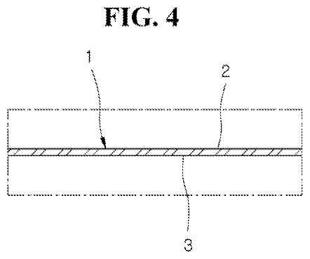

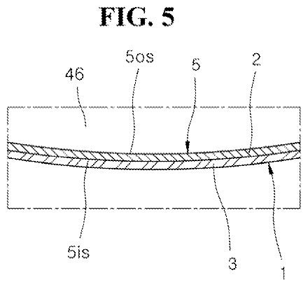

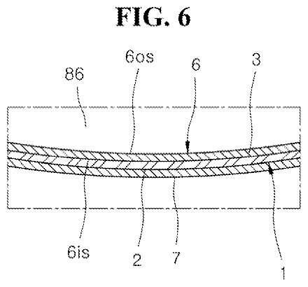

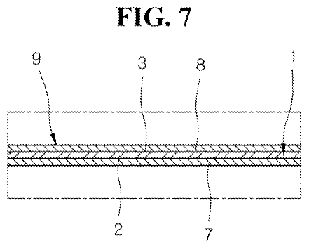

FIG. 1 is a diagram illustrating an electrode manufacturing apparatus according to one embodiment, FIG. 2 is a configuration diagram illustrating a first dryer of FIG. 1, FIG. 3 is a configuration diagram illustrating a second dryer of FIG. 1, FIG. 4 is an enlarged view illustrating portion IV of FIG. 1, FIG. 5 is an enlarged view illustrating portion V of FIG. 2, FIG. 6 is an enlarged view illustrating portion VI of FIG. 3, and FIG. 7 is an enlarged view illustrating portion VII of FIG. 1.

Referring to FIGS. 1 to 7, an electrode manufacturing apparatus 10 according to one embodiment may include, e.g., a first coating unit or first coater 20 and a first dryer 30. The first coater 20 may coat a first surface 2 of a current collector 1 with an electrode active material slurry 5. The first dryer 30 may come into contact with and may heat the current collector 1 that has passed through the first coater 20. The current collector 1 may be, e.g., a metal foil with a thin thickness. The electrode active material slurry may be a viscous liquid electrode active material.

The electrode manufacturing apparatus 10 may further include a second coater 60, a second dryer 70, a supply roller 11, and a collection roller 15. The second coater 60 may coat a second surface 3 of the current collector 1 with an electrode active material slurry 6 that has passed through the first dryer 30. The second dryer 70 may come into contact with and may heat the current collector 1 that has passed through the second coater 60.

The supply roller 11 may be a roller that unwinds the wound current collector 1 and supplies the unwound current collector 1 continuously without interruption. The collection roller 15 may be a roller that winds and collects a secondary battery electrode 9, which includes the current collector 1 and electrode active material layers 7 and 8 (formed by coating the first surface 2 and the second surface 3 of the current collector 1 with the electrode active material slurries 5 and 6 and drying and curing the electrode active material slurries 5 and 6).

The secondary battery electrode 9 may include the current collector 1 and the electrode active material layers 7 and 8 respectively on the first surface 2 and the second surface 3 of the current collector 1. The electrode active material layers 7 and 8 may be formed by drying and curing the electrode active material slurries 5 and 6, with which the current collector 1 has been coated. The second surface 3 of the current collector 1 may be a side surface facing away from (e.g., opposite to) the first surface 2.

The electrode manufacturing apparatus 10 may be an apparatus for sequentially performing, a process of coating the first surface 2 with the electrode active material slurry 5, a process of drying the electrode active material slurry 5 on the first surface 2, a process of coating the second surface 3 with the electrode active material slurry 6, and a process of drying the electrode active material slurry 6 on the second surface 3, as the current collector 1 travels from the supply roller 11 to the collection roller 15 continuously and without interruption. In an implementation, the electrode manufacturing apparatus 10 may be an apparatus for manufacturing the secondary battery electrode 9 through a roll-to-roller process.

The first coater 20 may include a first slurry coater 21 configured to coat the first surface 2 of the current collector 1 with the electrode active material slurry 5, and a first backup roller 25 on a side opposite to the first slurry coater 21 (with the current collector 1 therebetween). The first backup roller 25 may be configured to support the current collector 1 when the first surface 2 is coated with the electrode active material slurry 5.

In an implementation, the first slurry coater 21 may be, e.g., a slot die coater. In an implementation, the first slurry coater 21 may be another, suitable coater, e.g., a gravure coater or a comma coater.

The first dryer 30 may include first drying preheating rollers 41 and 43, first drying main heating rollers 46 and 48, first drying supplementary heating rollers 51 and 53, a first chamber 31, and a first ventilator 38. The rollers 41, 43, 46, 48, 51, and 53 in the first dryer 30 may include heaters generating heat by electrical energy therein. In an implementation, the heaters may generate heat, temperatures of outer circumferential surfaces of the rollers 41, 43, 46, 48, 51, and 53 may rise to a set heating temperature, and a uniform temperature distribution may appear over the entire areas of the outer circumferential surfaces.

The outer circumferential surfaces of the rollers 41, 43, 46, 48, 51, and 53 included in the first dryer 30 may come into contact with the current collector 1 traveling from the supply roller 11 to the collection roller 15 and may rotate due to friction with the current collector 1. In an implementation, at least one of the rollers 41, 43, 46, 48, 51, and 53 included in the first dryer 30 may be driven and rotated by the power of an electric motor.

The first drying main heating rollers 46 and 48 may come into contact with the electrode active material slurry 5, with which the first surface 2 of the current collector 1 is coated, and may heat the electrode active material slurry 5. The first drying supplementary heating rollers 51 and 53 may come into contact with the second surface 3 of the current collector 1, not coated with the electrode active material slurry 5, and may heat the second surface 3.

The first drying main heating rollers 46 and 48 may come into direct contact with the electrode active material slurry 5 and heat the electrode active material slurry 5. In an implementation, a large amount of heat may be transferred from the first drying main heating rollers 46 and 48 to the electrode active material slurry 5 (with which the first surface 2 is coated) so that the electrode active material slurry 5 may be quickly dried and cured into an electrode active material layer 7.

In an implementation, the first drying supplementary heating rollers 51 and 53 may come into contact with the second surface 3, and the electrode active material slurry 5 (with which the first surface 2 is coated) may be indirectly heated by the first drying supplementary heating rollers 51 and 53. In an implementation, the heat from the first drying supplementary heating rollers 51 and 53 may pass through the current collector 1 and may be transferred to the electrode active material slurry 5 with which the first surface 2 is coated.

The heat generated by the first drying supplementary heating rollers 51 and 53 may maintain a drying degree of an inner surface 5is of the electrode active material slurry 5, which is in contact with the current collector 1, similar to a drying degree of an outer surface 5os of the electrode active material slurry 5.

In an implementation, a plurality of first drying main heating rollers 46 and 48 and a plurality of first drying supplementary heating rollers 51 and 53 may be provided. In an implementation, the first dryer 30 may include a first first drying main heating roller 46, a second first drying main heating roller 48, a first first drying supplementary heating roller 51, and a second first drying supplementary heating roller 53.

In an implementation, the electrode manufacturing apparatus may include many more first drying main heating rollers and many more first drying supplementary heating rollers than those shown in the drawings. As the traveling speed of the current collector 1 is faster, the number of first drying main heating rollers and the number of first drying supplementary heating rollers may increase.

The plurality of first drying main heating rollers 46 and 48 and the plurality of first drying supplementary heating rollers 51 and 53 may be alternately disposed in a traveling direction of the current collector 1. In an implementation, the current collector 1 may be dried by sequentially passing the first first drying main heating roller 46, the first first drying supplementary heating roller 51, the second first drying main heating roller 48, and the second first drying supplementary heating roller 53, e.g., along a zigzag path.

The heating temperatures of the plurality of first drying main heating rollers 46 and 48 may gradually increase in the traveling direction of the current collector 1. In an implementation, the heating temperature of the first first drying main heating roller 46 may be, e.g., 120° C., and the heating temperature of the second first drying main heating roller 48 may be, e.g., 150° C.

If the heating temperatures of the plurality of first drying main heating rollers 46 and 48 were to gradually decrease or be the same temperature in the traveling direction of the current collector 1, the outer surface 5os could be excessively dried before the inside of the electrode active material slurry 5 with which the first surface 2 is coated is sufficiently dried. Thus, the inside of the electrode active material layer 7 (that is stacked on the first surface 2 and dried) could be insufficiently dried, or a surface of the electrode active material layer 7 (that is stacked on the first surface 2 and dried) could be excessively dried, and thus cracks could be formed.

The heating temperatures of the plurality of first drying supplementary heating rollers 51 and 53 may gradually increase in the traveling direction of the current collector 1. In an implementation, the heating temperature of the first first drying supplementary heating roller 51 may be, e.g., 80° C., and the heating temperature of the first drying second supplementary heating roller 53 may be, e.g., 100° C.

If the heating temperatures of the plurality of first drying supplementary heating rollers 51 and 53 were to gradually decrease or be the same temperature in the traveling direction of the current collector 1, the inner surface 5is could be excessively dried before the inside of the electrode active material slurry 5 (with which the first surface 2 is coated) is sufficiently dried. Thus, the inside of the electrode active material layer 7 (that is stacked on the first surface 2 and dried) could be insufficiently dried, or a surface of the electrode active material layer 7 (that is stacked on the first surface 2 and dried) could be excessively dried, and thus cracks could be formed.

In the first dryer 30, the heating temperatures of the first drying main heating rollers 46 and 48 may be higher than those of the first drying supplementary heating rollers 51 and 53. If the heating temperatures of the first drying main heating rollers 46 and 48 were to be lower than or equal to the heating temperatures of the first drying supplementary heating rollers 51 and 53, the energy consumed to dry the electrode active material slurry 5 on the first surface 2 could increase and a drying time could be prolonged, e.g., drying efficiency could be degraded.

The first drying preheating rollers 41 and 43 may be ahead of the first drying main heating rollers 46 and 48 and the first drying supplementary heating rollers 51 and 53 in the traveling direction of the current collector 1. Before the first drying main heating rollers 46 and 48 come into (e.g., direct) contact with the electrode active material slurry 5 and heat the electrode active material slurry 5, the first drying preheating rollers 41 and 43 may come into contact with the second surface 3, thereby preheating the current collector 1 and the electrode active material slurry 5.

If the first drying preheating rollers 41 and 43 were to come into direct contact with the electrode active material slurry 5 and heat the electrode active material slurry 5, the liquid electrode active material slurry 5 could adhere to the first drying preheating rollers 41 and 43. In an implementation, the first drying preheating rollers 41 and 43 may be provided as a plurality of first drying preheating rollers. In an implementation, the first dryer 30 may include a first first drying preheating roller 41 and a second first drying preheating roller 43.

The heating temperatures of the plurality of first drying preheating rollers 41 and 43 may gradually increase in the traveling direction of the current collector 1. In an implementation, the heating temperature of the first first drying preheating roller 41 may be, e.g., 150° C., and the heating temperature of the second first drying preheating roller 43 may be, e.g., 250° C.

In an implementation, the electrode manufacturing apparatus may include many more first drying preheating rollers than those shown in the drawings or may include only one first drying preheating roller. In an implementation, the traveling speed of the current collector 1 may be increased, and the number of first drying preheating rollers may increase.

The first chamber 31 may accommodate the first drying main heating rollers 46 and 48, the first drying supplementary heating rollers 51 and 53, and the first drying preheating rollers 41 and 43. An entrance opening 34 and an exit opening 35 may be in the first chamber 31 to allow the current collector 1 to pass through the first chamber 31. In an implementation, the first chamber 31 may collect the heat emitted from the rollers 41, 43, 46, 48, 51, and 53 included in the first dryer 30 so that the heat may not dissipate, and drying efficiency of the first dryer 30 may be improved.

The first ventilator 38 may discharge materials generated from the electrode active material slurry 5, e.g., a volatile solvent or water vapor, to the outside of the first chamber 31. In an implementation, the humidity inside the first chamber 31 may be properly maintained by the first ventilator 38, and the drying efficiency of the first dryer 30 and drying quality may be improved.

In an implementation, as shown in FIG. 2, only one ventilator 38 may be provided at a midpoint between the entrance opening 34 and the exit opening 35 of the first chamber 31, or a plurality of ventilators installed in the first chamber 31 may be provided, and an installation position may be different from the example shown in FIG. 2.

In an implementation, the electrode manufacturing apparatus 10 according to one embodiment may further include a roller raising/lowering part for minutely raising/lowering the rollers 41, 43, 46, 48, 51, and 53 included in the first dryer 30 in order to adjust a roller balance or the tension of the current collector 1.

The second coater 60 may include a second slurry coater 61 (configured to coat the second surface 3 of the current collector 1 with the electrode active material slurry 6), and a second backup roller 65 (on a side opposite to the second slurry coater 61 with the current collector 1 therebetween) configured to support the current collector 1 as the second surface 3 is coated with the electrode active material slurry 6.

The second slurry coater 61 may be, e.g., a slot die coater. In an implementation, the second slurry coater 61 may be, e.g., a gravure coater or a comma coater.

The second dryer 70 may include second drying preheating rollers 81 and 83, second drying main heating rollers 86 and 88, second drying supplementary heating rollers 91 and 93, a second chamber 71, and a second ventilator 78. The rollers 81, 83, 86, 88, 91, and 93 included in the second dryer 70 may include heaters for generating heat by electrical energy therein. In an implementation, the heaters may generate heat, temperatures of outer circumferential surfaces of the rollers 81, 83, 86, 88, 91, and 93 may rise to a set heating temperature, and a uniform temperature distribution may appear over the entire areas of the outer circumferential surfaces.

In an implementation, the first coater 20 and the first dryer 30 may be installed on a first floor or first level, and the second coater 60 and the second dryer 70 may be installed on a second level that is higher than the first level. With the above arrangement, an installation space of the electrode manufacturing apparatus 10 may be reduced.

The outer circumferential surfaces of the rollers 81, 83, 86, 88, 91, and 93 included in the second dryer 70 may come into contact with the current collector 1 traveling from the supply roller 11 to the collection roller 15 and may rotate due to friction with the current collector 1. In an implementation, at least one of the rollers 81, 83, 86, 88, 91, and 93 included in the second dryer 70 may be driven and rotated by the power of an electric motor.

The second drying main heating rollers 86 and 88 may come into contact with the electrode active material slurry 6, with which the second surface 3 of the current collector 1 is coated, and may heat the electrode active material slurry 6. The second drying supplementary heating rollers 91 and 93 may come into contact with the first surface 2 and heat the first surface 2. In an implementation, the second drying supplementary heating rollers 91 and 93 may come into contact with the electrode active material layer 7, which is formed by drying the electrode active material slurry 5, with which the first surface 2 is coated, and may heat the electrode active material layer 7.

The second drying main heating rollers 86 and 88 may come into direct contact with the electrode active material slurry 6, with which the second surface 3 is coated, and may heat the electrode active material slurry 6. Thus, a large amount of heat may be transferred from the second drying main heating rollers 86 and 88 to the electrode active material slurry 6 (with which the second surface 3 is coated) so that the electrode active material slurry 6 may be quickly dried and cured into an electrode active material layer 8.

In an implementation, the second drying supplementary heating rollers 91 and 93 may come into contact with the first surface 2 and may heat the first surface 2, the electrode active material layer 7 stacked on the first surface 2 may be brought into direct contact with the second drying supplementary heating rollers 91 and 93 and heated thereby, and the electrode active material slurry 6 with which the second surface 3 is coated may be indirectly heated by the second drying supplementary heating rollers 91 and 93. In an implementation, the heat from the second drying supplementary heating rollers 91 and 93 may pass through the current collector 1 and may be transferred to the electrode active material slurry 6 with which the second surface 3 is coated.

The heat generated by the second drying supplementary heating rollers 91 and 93 may maintain a drying degree of an inner surface 6is of the electrode active material slurry 6, which is in contact with the current collector 1, similar to a drying degree of an outer surface 6os of the electrode active material slurry 6.

The plurality of second drying main heating rollers 86 and 88 and the plurality of second drying supplementary heating rollers 91 and 93 may be provided. In an implementation, the second dryer 70 may include a first second drying main heating roller 86, a second second drying main heating roller 88, a first second drying supplementary heating roller 91, and a second second drying supplementary heating roller 93.

In an implementation, the electrode manufacturing apparatus may include many more second drying main heating rollers and many more second drying supplementary heating rollers than those shown in the drawings. In an implementation, the traveling speed of the current collector 1 may be increased, and the number of second drying main heating rollers and the number of second drying supplementary heating rollers may increase.

The plurality of second drying main heating rollers 86 and 88 and the plurality of second drying supplementary heating rollers 91 and 93 may be alternately disposed in the traveling direction of the current collector 1. In an implementation, the current collector 1 may be dried by sequentially passing the first second drying main heating roller 86, the first second drying supplementary heating roller 91, the second second drying main heating roller 88, and the second second drying supplementary heating roller 93, e.g., along a zigzag path.

The heating temperatures of the plurality of second drying main heating rollers 86 and 88 may gradually increase in the traveling direction of the current collector 1. In an implementation, the heating temperature of the first second drying main heating roller 86 may be, e.g., 250° C., and the heating temperature of the second second drying main heating roller 88 may be, e.g., 300° C.

If the heating temperatures of the plurality of second drying main heating rollers 86 and 88 were to gradually decrease or the same temperature in the traveling direction of the current collector 1, the outer surface 6os could be excessively dried before the inside of the electrode active material slurry 6, with which the second surface 3 is coated, is sufficiently dried. Thus, the inside of the electrode active material layer 8 that is stacked on the second surface 3 and dried could be insufficiently dried, or a surface of the electrode active material layer 8 that is stacked on the second surface 3 and dried could be excessively dried, and thus cracks could be formed.

The heating temperatures of the plurality of second drying supplementary heating rollers 91 and 93 may gradually increase in the traveling direction of the current collector 1. In an implementation, the heating temperature of the first second drying supplementary heating roller 91 may be, e.g., 80° C., and the heating temperature of the second second drying supplementary heating roller 93 may be, e.g., 100° C.

If the heating temperatures of the plurality of second drying supplementary heating rollers 91 and 93 were to gradually decrease or be the same temperature in the traveling direction of the current collector 1, the inner surface 6is could be excessively dried before the inside of the electrode active material slurry 6, with which the second surface 3 is coated, is sufficiently dried. Thus, the inside of the electrode active material layer 8 that is stacked on the second surface 3 and dried could be insufficiently dried, or a surface of the electrode active material layer 8 that is stacked on the second surface 3 and dried could be excessively dried, and thus cracks could be formed.

In the second dryer 70, the heating temperatures of the second drying main heating rollers 86 and 88 may be higher than those of the second drying supplementary heating rollers 91 and 93. If the heating temperatures of the second drying main heating rollers 86 and 88 were to be lower than or equal to the heating temperatures of the second drying supplementary heating rollers 91 and 93, the energy consumed to dry the electrode active material slurry 6 on the second surface 3 could increase and a drying time could be prolonged. In other words, drying efficiency could be degraded.

The electrode active material slurry 5, with which the first surface 2 is coated, may be dried by receiving the heat from not only the first dryer 30 but also the second dryer 70, and the electrode active material slurry 6, with which the second surface 3 is coated, may be dried by receiving the heat only from the second dryer 70. Therefore, in order to secure a uniform drying degree between the electrode active material layers 7 and 8 respectively formed on the first surface 2 and the second surface 3, the heating temperatures of the second drying main heating rollers 86 and 88 may be higher than those of the first drying main heating rollers 46 and 48.

The second drying preheating rollers 81 and 83 may be ahead of the second drying main heating rollers 86 and 88 and the second drying supplementary heating rollers 91 and 93 in the traveling direction of the current collector 1. Before the second drying main heating rollers 86 and 88 come into direct contact with the electrode active material slurry 6, with which the second surface 3 is coated, and heat the electrode active material slurry 6, the second drying preheating rollers 81 and 83 come into contact with the electrode active material layer 7 stacked and formed on the first surface 2, thereby preheating the current collector 1 and the electrode active material slurry 6.

If the second drying preheating rollers 81 and 83 were to come into direct contact with the electrode active material slurry 6, with which the second surface 3 is coated, and heat the electrode active material slurry 6, the liquid electrode active material slurry 6 could adhere to the second drying preheating rollers 81 and 83. The second drying preheating rollers 81 and 83 may be provided as a plurality of second drying preheating rollers. In an implementation, the second dryer 70 may include a first second drying preheating roller 81 and a second second drying preheating roller 83.

The heating temperatures of the plurality of second drying preheating rollers 81 and 83 may gradually increase in the traveling direction of the current collector 1. In an implementation, the heating temperature of the first second drying preheating roller 81 may be, e.g., 150° C., and the heating temperature of the second second drying preheating roller 83 may be, e.g., 250° C.

In an implementation, the electrode manufacturing apparatus may include many more second drying preheating rollers than that shown in the drawings or may include only one second drying preheating roller. In an implementation, the traveling speed of the current collector 1 may increase, and the number of second drying preheating rollers may increase.

The second chamber 71 may accommodate the second drying main heating rollers 86 and 88, the second drying supplementary heating rollers 91 and 93, and the second drying preheating rollers 81 and 83. An entrance opening 74 and an exit opening 75 may be in the second chamber 71 to allow the current collector 1 to pass through the second chamber 71. The second chamber 71 collects the heat emitted from the rollers 81, 83, 86, 88, 91, and 93 included in the second dryer 70 so that the heat does not dissipate, and the drying efficiency of the second dryer 70 may be improved.

The second ventilator 78 may discharge materials generated from the electrode active material slurry 5, e.g., a volatile solvent or water vapor, to the outside of the second chamber 71. The humidity inside the second chamber 71 may be properly maintained by the second ventilator 78, and the drying efficiency of the second dryer 70 and drying quality can be improved. In an implementation, as shown in FIG. 3, only one ventilator 78 may be provided at a midpoint between the entrance opening 74 and the exit opening 75 of the second chamber 71, or a plurality of ventilators installed in the second chamber 71 may be provided, and an installation position may be different from the example shown in FIG. 3.

In an implementation, the electrode manufacturing apparatus 10 may further include a roller raising/lowering part for minutely raising/lowering the rollers 81, 83, 86, 88, 91, and 93 included in the second dryer 70 in order to adjust a roller balance or the tension of the current collector 1.

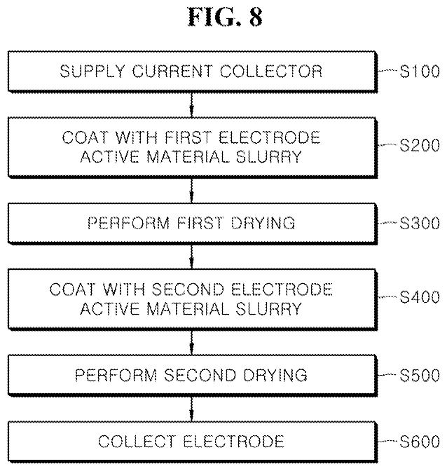

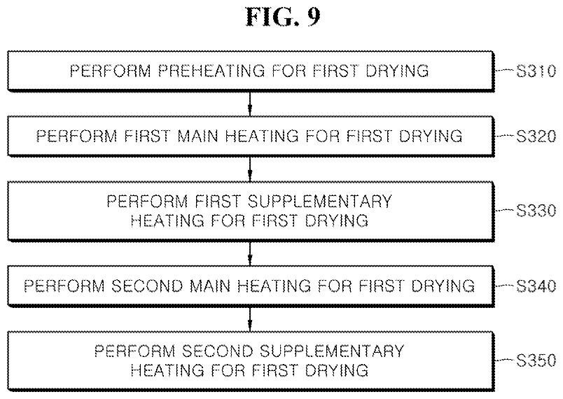

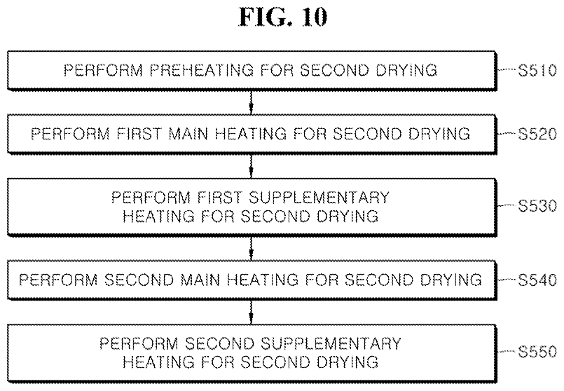

FIG. 8 is a flowchart illustrating an electrode manufacturing method according to one embodiment, FIG. 9 is a flowchart illustrating a first drying operation of FIG. 8 in detail, and FIG. 10 is a flowchart illustrating a second drying operation of FIG. 8 in detail. The electrode manufacturing method according to one embodiment may be implemented as a roll-to-roller process through, e.g., the electrode manufacturing apparatus 10 described with reference to FIGS. 1 to 7.

Referring to FIGS. 1 to 9, the electrode manufacturing method according to one embodiment may include performing a first electrode active material slurry coating operation S200 and a first drying operation S300. The first electrode active material slurry coating operation S200 is an operation of coating the first surface 2 of the current collector 1 with the electrode active material slurry 5.

The first drying operation S300 may be an operation of bringing heating rollers into contact with the current collector 1 and heating the current collector 1 after the first electrode active material slurry coating operation S200. The first drying operation S300 may include first drying main heating operations S320 and S340, in which the first drying main heating rollers 46 and 48 come into contact with the electrode active material slurry 5, with which the first surface 2 of the current collector 1 is coated, and heat the electrode active material slurry 5, and first drying supplementary heating operations S330 and S350, in which the supplementary heating rollers 51 and 53 for first drying come into contact with the second surface 3 of the current collector 1 and heat the second surface 3.

The electrode manufacturing method according to one embodiment may further include performing a current collector supply operation S100 prior to the first electrode active material slurry coating operation S200, and a second electrode active material slurry coating operation S400, a second drying operation S500, and an electrode collecting operation S600 after the first drying operation S300.

The current collector supply operation S100 may be an operation of unwinding a wound current collector 1 and supplying the unwound current collector 1 continuously without interruption. The current collector supply operation S100 may be performed by the supply roller 11 described with reference to FIG. 1. The first electrode active material slurry coating operation S200 may be performed by the first coater 20 described with reference to FIG. 1.

The first drying main heating operations S320 and S340 may be performed a plurality of times. The first drying supplementary heating operations S330 and S350 may be performed a plurality of times. The plurality of first drying main heating operations S320 and S340 and the plurality of first drying supplementary heating operations S330 and S350 may be alternately performed.

In an implementation, the first drying main heating operations S320 and S340 may include a first first drying main heating operation S320 and a second first drying main heating operation S340, and the first drying supplementary heating operations S330 and S350 may include a first first drying supplementary heating operation S330 and a second first drying supplementary heating operation S350.

In an implementation, in the first drying operation S300, the first first drying main heating operation S320, the first first drying supplementary heating operation S330, the second first drying main heating operation S340, and the second first drying supplementary heating operation S350 may be sequentially performed.

In the plurality of first drying main heating operations S320 and S340, heating temperatures at which the first drying main heating rollers 46 and 48 heat the current collector 1 may gradually increase in the traveling direction of the current collector 1. In the plurality of first drying supplementary heating operations S330 and S350, heating temperatures at which the first drying supplementary heating rollers 51 and 53 heat the current collector 1 may gradually increase in the traveling direction of the current collector 1.

A heating temperature at which the current collector 1 is heated in the first drying main heating operations S320 and S340 may be higher than a heating temperature at which the current collector 1 is heated in the first drying supplementary heating operations S330 and S350.

The first drying operation S300 may further include a first drying preheating operation S310. The first drying preheating operation S310 may include an operation of bringing preheating rollers into contact with the second surface 3 and heating the second surface 3 prior to performing the first drying main heating operations S320 and S340 and the first drying supplementary heating operations S330 and S350. In this way, the current collector 1 may be preheated. The first drying operation S300 may be performed in the first dryer 30 described with reference to FIG. 2.

The second electrode active material slurry coating operation S400 may include an operation of coating the second surface 3 of the current collector 1 with the electrode active material slurry 6 and may be performed by the second coater 60 described with reference to FIG. 1.

The second drying operation S500 may include an operation of bringing heating rollers into contact with the current collector 1 and heating the current collector 1 after performing the second electrode active material slurry coating operation S400. The second drying operation S500 may include second drying main heating operations S520 and S540, in which the second drying main heating rollers 86 and 88 come into contact with the electrode active material slurry 6, with which the second surface 3 is coated, and heat the electrode active material slurry 6, and second drying supplementary heating operations S530 and S550 in which the second drying supplementary heating rollers 91 and 93 come into contact with the first surface 2 of the current collector 1 and heat the first surface 2. In an implementation, in the second drying supplementary heating operations S530 and S550, the second drying supplementary heating rollers 91 and 93 may come into contact with the electrode active material layer 7, which may be formed by stacking the electrode active material slurry 5 on the first surface 2 and drying the electrode active material slurry 5, and heat the electrode active material layer 7.

The second drying main heating operations S520 and S540 may be performed a plurality of times. The second drying supplementary heating operations S530 and S550 may be performed a plurality of times. The plurality of second drying main heating operations S520 and S540 and the plurality of second drying supplementary heating operations S530 and S550 may be alternately performed.

In an implementation, the second drying main heating operations S520 and S540 may include a first second drying main heating operation S520 and a second second drying main heating operation S540, and the second drying supplementary heating operations S530 and S550 may include a first second drying supplementary heating operation S530 and a second second drying supplementary heating operation S550.

In an implementation, in the second drying operation S500, the first second drying main heating operation S520, the first second drying supplementary heating operation S530, the second second drying main heating operation S540, and the second second drying supplementary heating operation S550 may be sequentially performed.

In the plurality of second drying main heating operations S520 and S540, heating temperatures at which the second drying main heating rollers 86 and 88 heat the current collector 1 may gradually increase in the traveling direction of the current collector 1. In the plurality of second drying supplementary heating operations S530 and S550, heating temperatures at which the second drying supplementary heating rollers 91 and 93 heat the current collector 1 may gradually increase in the traveling direction of the current collector 1.

A heating temperature at which the current collector 1 is heated in the second drying main heating operations S520 and S540 may be higher than a heating temperature at which the current collector 1 is heated in the second drying supplementary heating operations S530 and S550. A heating temperature at which the current collector 1 is heated in the second drying main heating operations S520 and 540 may be higher than a heating temperature at which the current collector 1 is heated in the first drying main heating operations S320 and S340.

The second drying operation S500 may further include performing a second drying preheating operation S510. The second drying preheating operation S510 may include an operation of bringing preheating rollers into contact with the first surface 2, e.g., the electrode active material layer 7 stacked and formed on the first surface 2, and heating the first surface 2 prior to the second drying main heating operations S520 and S540 and the second drying supplementary heating operations S530 and S550. In this way, the current collector 1 may be preheated. The second drying operation S500 may be performed in the second dryer 70 described with reference to FIG. 3.

The electrode collecting operation S600 may include an operation of winding and collecting the secondary battery electrode 9, which includes the current collector 1 and the electrode active material layers 7 and 8 formed by coating the first surface 2 and the second surface 3 of the current collector 1 with the electrode active material slurries 5 and 6 and drying and curing the electrode active material slurries 5 and 6. The electrode collecting operation S600 may be performed by the collection roller 15 described with reference to FIG. 1.

As described above, in accordance with the electrode manufacturing apparatus 10 and the electrode manufacturing method according to the embodiments, the heating rollers 46, 48, 51, 53, 86, 88, 91, and 93 may come into contact with the entire area coated with the electrode active material slurries 5 and 6, at a uniform pressure and heat the entire area (e.g., over time) at a uniform temperature, the thicknesses and drying quality of the electrode active material layers 7 and 8 may be uniform, and no cracks may be formed in the electrode active material layers 7 and 8. Therefore, the productivity of the secondary battery electrode 9 with good quality may be improved and manufacturing costs may be reduced.

By way of summation and review, during a process of manufacturing a secondary battery electrode, cracks could be formed in the electrode active material or defects in which a thickness of the electrode active material is not uniform across an entire area could frequently occur so that productivity of good quality secondary battery electrodes could be degraded and manufacturing costs could be increased.

One or more embodiments may provide an electrode manufacturing apparatus and an electrode manufacturing method, in which the thickness and drying quality of an electrode active material layer formed by curing a current collector coated with an electrode active material slurry is uniform and no cracks are formed in the electrode active material layer.

According to the embodiments, the heating rollers may come into contact with the entire area coated with the electrode active material slurries, at a uniform pressure and heat the entire area at a uniform temperature, the thicknesses and drying quality of the electrode active material layers may be uniform, and no cracks may be formed in the electrode active material layers. Therefore, the productivity of the electrode of a secondary battery with good quality may be improved and manufacturing costs can be reduced.

Example embodiments have been disclosed herein, and although specific terms are employed, they are used and are to be interpreted in a generic and descriptive sense only and not for purposes of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An electrode manufacturing apparatus, comprising:
a first coater configured to coat a first surface of a current collector with an electrode active material slurry; and
a first dryer configured to come into contact with the current collector that has passed through the first coater and heat the current collector.

2. The electrode manufacturing apparatus as claimed in claim 1, wherein the first dryer includes:
at least one first drying main heating roller configured to come into contact with the electrode active material slurry coated on the first surface and heat the electrode active material slurry; and
at least one first drying supplementary heating roller configured to come into contact with a second surface of the current collector and heat the second surface.

3. The electrode manufacturing apparatus as claimed in claim 2, wherein the at least one first drying main heating roller and the at least one first drying supplementary heating roller are alternately disposed in a traveling direction of the current collector.

4. The electrode manufacturing apparatus as claimed in claim 2, wherein a heating temperature of the at least one first drying main heating roller is higher than a heating temperature of the at least one first drying supplementary heating roller.

5. The electrode manufacturing apparatus as claimed in claim 2, wherein:
the at least one first drying main heating roller includes a plurality of first drying main heating rollers; and
heating temperatures of the plurality of first drying main heating rollers gradually increase in a traveling direction of the current collector.

6. The electrode manufacturing apparatus as claimed in claim 2, wherein:
the at least one first drying supplementary heating roller includes a plurality of first drying supplementary heating rollers; and
heating temperatures of the plurality of first drying supplementary heating rollers gradually increase in a traveling direction of the current collector.

7. The electrode manufacturing apparatus as claimed in claim 2, wherein the first dryer further includes at least one first drying preheating roller ahead of the at least one first drying main heating roller and the at least one first drying supplementary heating roller in a traveling direction of the current collector, the at least one first drying preheating roller being configured to come into contact with the second surface and heat the second surface.

8. The electrode manufacturing apparatus as claimed in claim 2, wherein the first dryer further includes:
a first chamber that accommodates the at least one first drying main heating roller and the at least one first drying supplementary heating roller, and through which the current collector passes; and
a first ventilator configured to discharge a material generated from the electrode active material slurry to the outside of the first chamber.

9. The electrode manufacturing apparatus as claimed in claim 1, further comprising:
a second coater configured to coat a second surface of the current collector with an electrode active material slurry that has passed through the first dryer; and
a second dryer configured to come into contact with the current collector that has passed through the second coater and heat the current collector.

10. The electrode manufacturing apparatus as claimed in claim 9, wherein the second dryer includes:
at least one second drying main heating roller configured to come into contact with the electrode active material slurry coated on the second surface and heat the electrode active material slurry; and
at least one second drying supplementary heating roller configured to come into contact with the first surface of the current collector and heat the first surface.

11. The electrode manufacturing apparatus as claimed in claim 10, wherein the at least one second drying main heating roller and the at least one second drying supplementary heating roller are alternately disposed in a traveling direction of the current collector.

12. The electrode manufacturing apparatus as claimed in claim 10, wherein a heating temperature of the at least one second drying main heating roller is higher than a heating temperature of the at least one second drying supplementary heating roller.

13. The electrode manufacturing apparatus as claimed in claim 10, wherein:
the at least one second drying main heating roller includes a plurality of second drying main heating rollers; and
heating temperatures of the plurality of second drying main heating rollers gradually increase in a traveling direction of the current collector.

14. The electrode manufacturing apparatus as claimed in claim 10, wherein:
the at least one second drying supplementary heating roller includes a plurality of second drying supplementary heating rollers; and
heating temperatures of the plurality of second drying supplementary heating rollers gradually increase in a traveling direction of the current collector.

15. The electrode manufacturing apparatus as claimed in claim 10, wherein the second dryer further includes at least one second drying preheating roller ahead of the at least one second drying main heating roller and the at least one second drying supplementary heating roller in a traveling direction of the current collector, the at least one second drying preheating roller being configured to come into contact with the first surface and heat the first surface.

16. The electrode manufacturing apparatus as claimed in claim 10, wherein the second dryer further includes:
a second chamber that accommodates the at least one second drying main heating roller and the at least one second drying supplementary heating roller, and through which the current collector passes; and
a second ventilator configured to discharge a material generated from the electrode active material slurry to the outside of the second chamber.

17. An electrode manufacturing method, the method comprising:
performing a first electrode active material slurry coating operation of coating a first surface of a current collector with an electrode active material slurry; and
performing a first drying operation including a first drying main heating operation in which a first drying main heating roller comes into contact with the electrode active material slurry coated on the first surface, and heats the electrode active material slurry, and a first drying supplementary heating operation in which a first drying supplementary heating roller comes into contact with a second surface and heats the second surface.

18. The electrode manufacturing method as claimed in claim 17, wherein:
the first drying main heating operation is performed a plurality of times;
the first drying supplementary heating operation is performed a plurality of times; and
the first drying main heating operation and the first drying supplementary heating operation are alternately performed the plurality of times.

19. The electrode manufacturing method as claimed in claim 17, further comprising:
performing a second electrode active material slurry coating operation of coating the second surface of the current collector with an electrode active material slurry after performing the first drying operation; and
performing a second drying operation including a second drying main heating operation in which a second drying main heating roller comes into contact with the electrode active material slurry coated on the second surface, and heats the electrode active material slurry, and a second drying supplementary heating operation in which a second drying main heating roller comes into contact with the first surface and heats the first surface.

20. The electrode manufacturing method as claimed in claim 19, wherein:
the second drying main heating operation is performed a plurality of times;
the second drying supplementary heating operation is performed a plurality of times; and
the second drying main heating operation and the second drying supplementary heating operation are alternately performed the plurality of times.
